(19) United States
(12) Patent Application Publication
(10) Pub. No.: US 2024/0100723 A1
(43) Pub. Date: Mar. 28, 2024

(54) FOLDING UTILITY KNIFE

(71) Applicant: APEX BRANDS, INC., Apex, NC (US)

(72) Inventor: Steven Richard Germann, Rio Rico, AZ (US)

(21) Appl. No.: 18/242,880

(22) Filed: Sep. 6, 2023

Related U.S. Application Data
(60) Provisional application No. 63/377,199, filed on Sep. 27, 2022.

(51) Int. Cl. B26B 5/00

(52) U.S. Cl. CPC B26B 5/00

(57) ABSTRACT

A folding utility knife is provided that includes a blade carrier pivotably secured to a handle. The blade carrier includes a housing in which a blade pocket is formed. The blade pocket defines a top edge and an opposing blade opening; and a pair of side edges located on opposite sides of the blade pocket, extending between the top edge and the blade opening. The blade pocket also defines a pair of detents located proximate the pair of side edges, between the top edge and the blade opening, spatially separated from the top edge and the blade opening. The blade pocket is contoured to fit a top portion of a utility blade that includes a pair of openings, and the pair of detents are contoured to fit within the pair of openings to position and hold the top portion of the utility blade within the blade pocket.

### TECHNOLOGICAL FIELD

The present disclosure relates generally to utility knives and, in particular, to a utility blade, and a holder such as a blade carrier of a folding utility knife.

### BACKGROUND

Modern utility knives typically include a housing, a moveable blade carrier, and a utility blade. The blade carrier is mounted in the housing so as slide back and forth inside the housing. The utility blade is coupled to the blade carrier so as to move between an extended or deployed cutting position (carrier forward) and a retracted position (carrier back). The utility blade typically has a trapezoid shape with a razor sharp cutting edge along the long lower side, and two small U-shaped notches along an opposing shorter top edge for mating the utility blade to the blade carrier.

Many current utility knives suffer a number of drawbacks. The two small U-shaped notches by which the utility blade is mated to the blade carrier in some cases is insufficient to prevent the utility blade from being pulled out of the blade carrier during use. This mechanism for holding the utility blade in the blade carrier also often requires that a greater amount of the utility blade is held inside the blade carrier, which limits the length of the cutting edge that is exposed and thereby useful.

It would therefore be desirable to have a utility blade and holder for the utility blade that takes into account at least some of the issues discussed above, as well as other possible issues.

### BRIEF SUMMARY

Example implementations of the present disclosure are directed to utility knives and, in particular, to a utility blade, and a holder such as a blade carrier of a folding utility knife. The present disclosure includes, without limitation, the following example implementations.

Some example implementations provide a utility blade comprising a blade body having a convex quadrilateral shape, the blade body defining at least: a top edge; a linear cutting edge on an opposite side of the blade body from the top edge; a pair of side edges located on opposite sides of the blade body, extending between the top edge and the linear cutting edge; and a pair of openings located proximate the pair of side edges, between the top edge and the linear cutting edge, the pair of openings spatially separated from the top edge and the linear cutting edge, a top portion of the utility blade contoured to fit within a holder that includes a pair of detents, and the pair of openings contoured to fit the pair of detents to position and hold the utility blade within the holder.

Some example implementations provide a holder for a utility blade that includes a pair of openings, the holder comprising a housing in which a blade pocket is formed, the blade pocket defining at least: a top edge; a blade opening on an opposite side of the blade pocket from the top edge; a pair of side edges located on opposite sides of the blade pocket, extending between the top edge and the blade opening; and a pair of detents located proximate the pair of side edges, between the top edge and the blade opening, the pair of detents spatially separated from the top edge and the blade opening, the blade pocket contoured to fit a top portion of the utility blade, and the pair of detents contoured to fit within the pair of openings to position and hold the top portion of the utility blade within the blade pocket.

Some example implementations provide a folding utility knife comprising: a handle; and a blade carrier that is pivotably secured to the handle, the blade carrier pivotable between a closed position in which the blade carrier is pivoted inwardly toward the handle, and an open position in which the blade carrier is pivoted outwardly relative to the handle, the blade carrier including a housing in which a blade pocket is formed, the blade pocket defining at least: a top edge; a blade opening on an opposite side of the blade pocket from the top edge; a pair of side edges located on opposite sides of the blade pocket, extending between the top edge and the blade opening; and a pair of detents located proximate the pair of side edges, between the top edge and the blade opening, spatially separated from the top edge and the blade opening, the blade pocket contoured to fit a top portion of a utility blade that includes a pair of openings, and the pair of detents contoured to fit within the pair of openings to position and hold the top portion of the utility blade within the blade pocket.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1 and 2 illustrate a utility blade with a pair of openings located between a top edge and a linear cutting edge, according to various example implementations of the present disclosure;

FIGS. 3 and 4 illustrate the utility blade further including one or more indentations on its top edge, according to various example implementations;

FIGS. 5-8 illustrate a folding utility knife including a blade carrier and a handle, according to various example implementations;

FIGS. 9 and 10 further illustrate the blade carrier of the folding utility knife, according to various example implementations;

FIGS. 11 and 12 illustrate a housing of the blade carrier in which a blade pocket is formed, according to various example implementations;

FIGS. 13 and 14 illustrate a cover for the housing of the blade carrier, according to various example implementations;

FIGS. 15A and 15B further illustrate the cover secured to the housing of the blade carrier configured to hold the utility blade of FIG. 1, according to some example implementations;

FIGS. 16A and 16B further illustrate the cover secured to the housing of the blade carrier configured to hold the utility blade of FIG. 2, according to some example implementations;

FIGS. 17 and 18 are exploded views of the folding utility knife, according to various example implementations; and

FIGS. 19 and 20 are exploded views of a utility scraper, according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

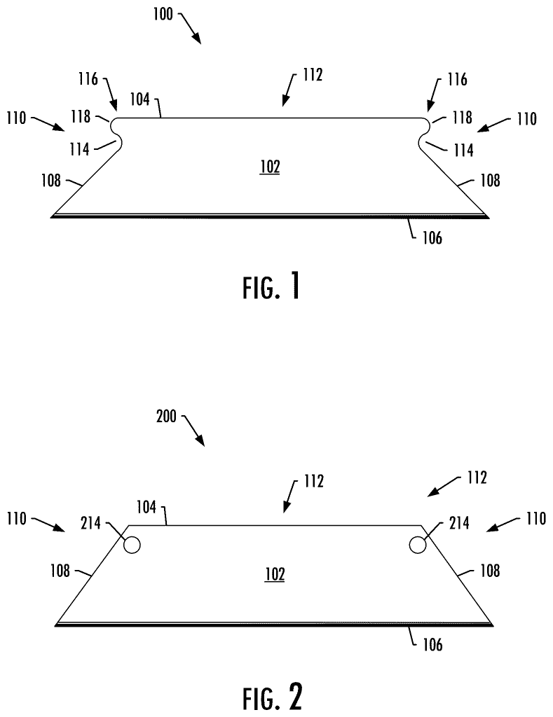

Example implementations of the present disclosure relate generally to utility knives and, in particular, to a utility blade, and a holder such as a blade carrier of a folding utility knife. FIG. 1 illustrates a utility blade 100 according to various example implementations of the present disclosure. As shown, the utility blade has a blade body 102 having a convex quadrilateral shape. The blade body defines a top edge 104, a linear cutting edge 106 on an opposite side of the blade body from the top edge, and a pair of side edges 108 located on opposite sides of the blade body, extending between the top edge and the linear cutting edge. As also shown, the blade body defines a pair of openings 110 located proximate the pair of side edges, between the top edge and the linear cutting edge; and the pair of openings are spatially separated from the top edge and the linear cutting edge. In some examples, openings of the pair of openings may be located closer to respective side edges of the pair of side edges than to each other.

In some examples, the pair of openings 110 include indentations 114 defined by respective side edges of the pair of side edges 108. The indentations may have any of a number of different such as a concave arcuate shape (shown), a U-shape, V-shape or the like. In some more particular examples, the indentations are undercuts defined in the respective side edges that leave overhanging portions 116 of the top edge 104. And in some of these examples, each undercut defined by a side edge of the respective side edges may have a concave arcuate shape, and the side edge may include a convex arcuate transition 118 from the undercut to a respective one of the overhanging portions of the top edge 104.

FIG. 2 illustrates a utility blade 200 according to other example implementations. The utility blade 200 is similar to the utility blade 100, including that it includes a blade body 102 that defines a pair of openings 110. As shown in FIG. 2, however, openings of the pair of openings 110 are holes 214 defined in the blade body 102, located proximate to but spatially separated from the pair of side edges 108.

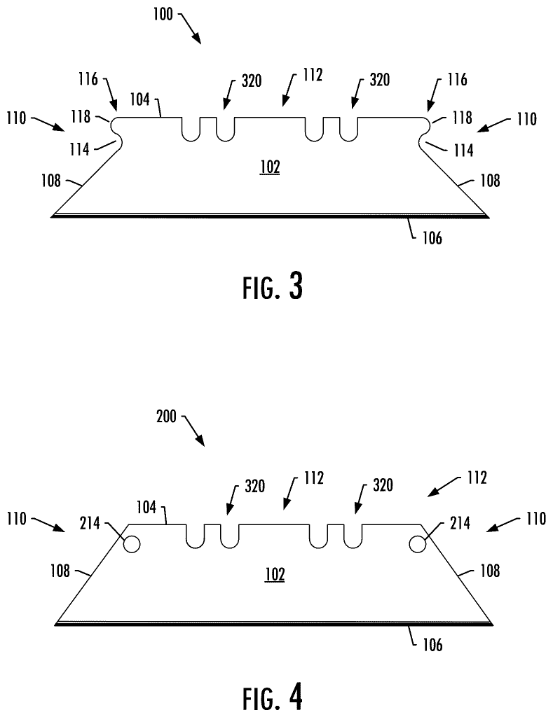

The utility blade 100, 200 may be fit to any of a number of different holders, some of which may be embodied as a blade carrier for a retractable utility knife, a foldable utility knife, a scraper or the like. In this regard, as described in greater detail below, a top portion 112 of the utility blade is contoured to fit within a holder that includes a pair of detents, with the pair of openings contoured to fit the pair of detents to position and hold the utility blade within the holder. In some examples, as shown in FIGS. 3 and 4 for respectively utility blade 100 and utility blade 200, the top edge 104 of the utility blade defines one or more indentations 320 that are contoured to fit one or more further detents within the holder. These one or more indentations may have any of a number of different such as a U-shape (shown), V-shape or the like.

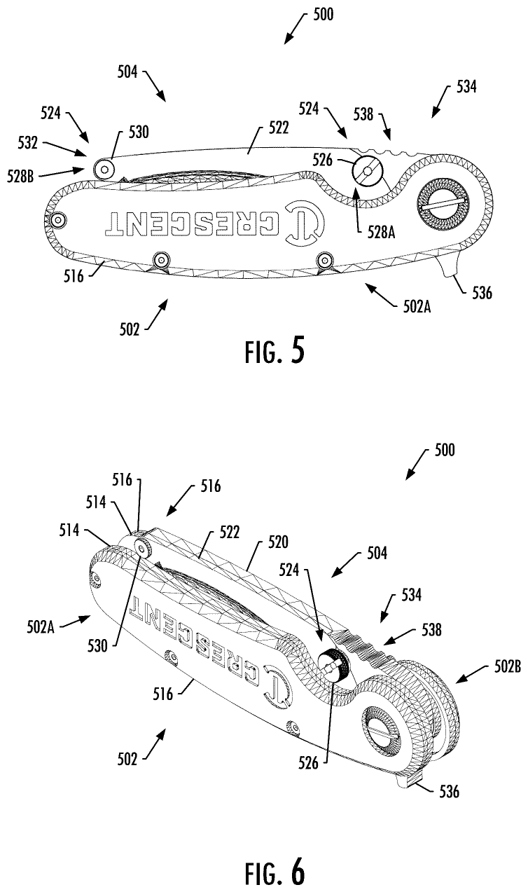

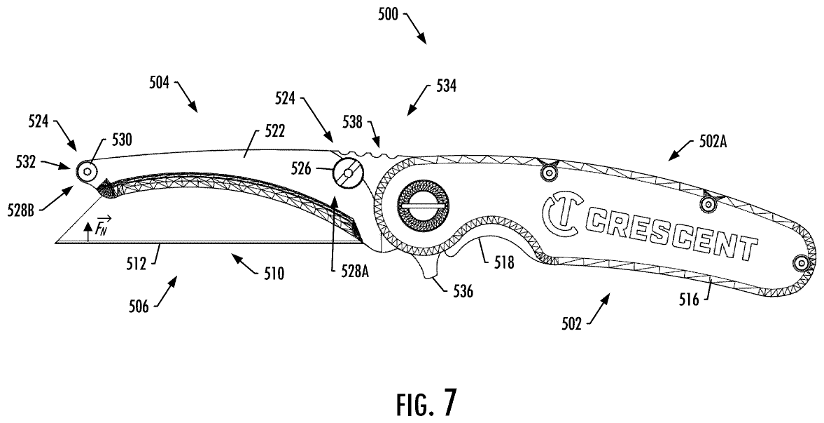

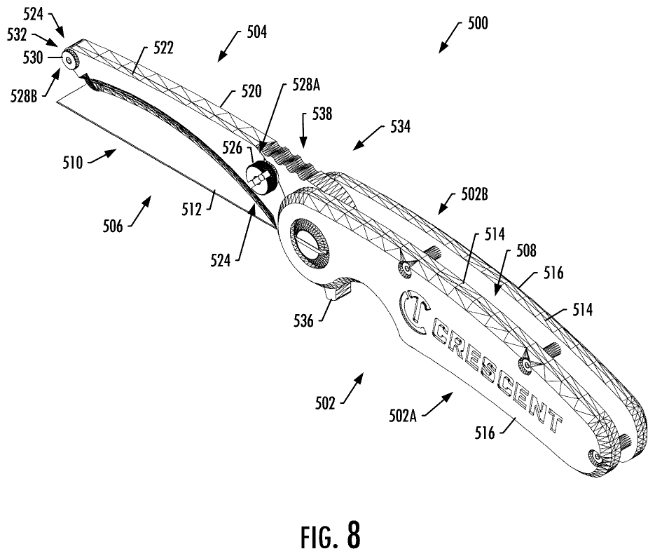

FIGS. 5-8 illustrate a folding utility knife 500 according to various example implementations of the present disclosure. As shown, for example, the folding utility knife includes a handle 502, and a blade carrier 504 that is pivotably secured to the handle. The blade carrier is configured to hold a utility blade 506 that may correspond to utility blade 100 or utility blade 200. The blade carrier is pivotable between a closed position in which the blade carrier (and thereby the utility blade) is pivoted inwardly toward the handle, and an open position in which the blade carrier (and thereby the utility blade) is pivoted outwardly relative to the handle. In this regard, FIGS. 5 and 6 illustrate side and perspective views of the folding utility knife in the closed position, and FIGS. 7 and 8 illustrate side and perspective views of the folding utility knife in the open position.

In some examples, the handle 502 includes first and second handle portions 502A, 502B that are secured to each other in a spaced apart relationship to define an interior space 508 in which at least a bottom portion 510 of the utility blade 506 that includes its linear cutting edge 512 (e.g., linear cutting edge 106) is stowed when the blade carrier 504 is in the closed position. The folding utility knife in various examples may include a locking mechanism such as a frame lock, a liner lock or the like, which may be configured to engage when the blade carrier is pivoted to the open position, and disengage responsive to an applied force to enable the blade carrier to pivot from the open position to the closed position. In some examples including a frame lock, the first and second handle portions are scales, and one of the scales is configured as or includes a frame lock. In other examples including a liner lock (shown), the first and second handle portions include respective liners 514 and scales 516, and one of the liners is configured as or includes a liner lock 518.

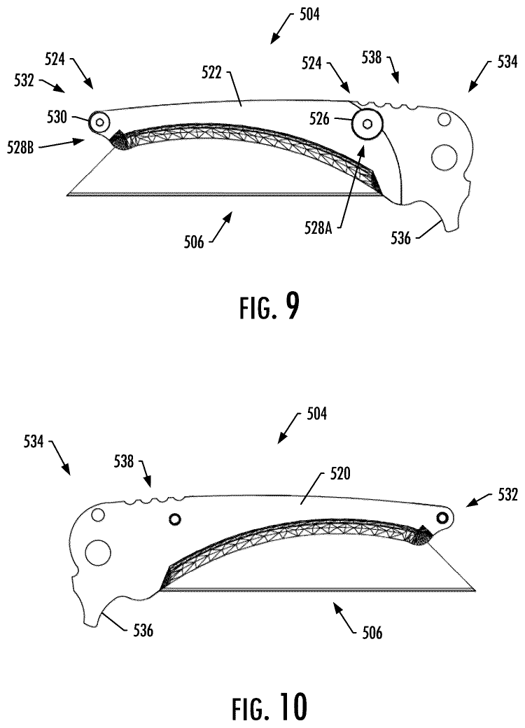

FIGS. 9 and 10 further illustrate the blade carrier 504 according to various example implementations. As shown in FIGS. 5-8, and further in FIGS. 9 and 10, the blade carrier 504 includes a housing 520 for receipt of the utility blade 506; and in some examples, the housing defines a blade pocket contoured to fit a top portion of the utility blade. The blade pocket and the top portion of the utility blade are under cover in FIGS. 5-10, although the top portion of the utility blade may correspond to the top portion 112 of utility blade 100, 200. In some examples, the housing is sized such that more than 75% of the linear cutting edge 512 of the utility blade is exposed when the top portion of the utility blade is fit into the housing (e.g., into the blade pocket of the housing). In some further examples, the housing is sized such that all of the linear cutting edge of the utility blade is exposed.

In some examples, the blade carrier 504 also includes a cover 522 that is securable to the housing 520 over the top portion of the utility blade 506 to hold the utility blade firmly in the housing, or more particularly in the blade pocket of the housing. In some of these examples, the housing and the cover are sized such that less than 25% of the linear cutting edge 512 of the utility blade is covered when the top portion of the utility blade is fit into the housing and the cover is secured over the top portion of the utility blade. In further examples, the housing and the cover may be sized such that none of the linear cutting edge of the utility blade is covered.

The cover 522 may be secured to the housing 520 of the blade carrier 504 in any of a number of different manners. The blade carrier may further include at least one fastener 524 configured to secure the cover to the housing. The at least one fastener may include a tensioning fastener 526 such as a thumb screw, loosened to provide access to the blade pocket of the housing for insertion or replacement of the utility blade 506, and tightened to hold the utility blade firmly in the blade pocket. The at least one fastener may include a pair of tensioning fasteners configured to secure respective ends 528A, 528B of the cover to the housing.

As shown in FIGS. 5-9, the at least one fastener 524 of the blade carrier 504 may include a tensioning fastener 526 configured to removably secure a first end 528A of the cover 522 to the housing 520, and a pivot pin 530 configured to pivotably secure a second end 528B of the cover to the housing. The tensioning fastener may be located proximate the handle 502, and the pivot pin may be located proximate a distal end 532 of the housing. In this regard, the tensioning fastener may be located proximate the handle, as a thumb stud in which a force applied to the thumb stud promotes pivot of the blade carrier (and thereby the utility blade 506) from the closed position to the open position.

In some examples, the blade carrier 504 includes a tang 534 secured to or integrated with the housing 520; and in some of these examples, the blade carrier may be pivotably secured to the handle 502 at the tang. In some further examples, the tang includes a tab 536 that juts out from a back of the handle when the blade carrier is in the closed position. A force applied to the tab, then, may promote pivot of the blade carrier from the closed position to the open position. Additionally or alternatively, the tang may include jumping 538 with a series of notches configured to provide a thumb grip on the blade carrier when the blade carrier is in the open position.

As indicated above, according to some example implementations, a blade pocket is formed in the housing 520 of the blade carrier 504, and the blade pocket is contoured to fit the top portion of the utility blade 506. The utility blade may correspond to utility blade 100 or utility blade 200; and accordingly, the blade pocket may be contoured to fit the top portion 112 of utility blade 100 or utility blade 200. In this regard, FIG. 11 illustrates the housing including a blade pocket 1100 contoured to fit the top portion of utility blade 100, according to various example implementations.

As shown, the blade pocket 1100 defines a top edge 1102, a blade opening 1104 on an opposite side of the blade pocket from the top edge, and a pair of side edges 1106 located on opposite sides of the blade pocket, extending between the top edge and the blade opening. As also shown, the blade pocket defines a pair of detents 1108 located proximate the pair of side edges, between the top edge and the blade opening, and spatially separated from the top edge and the blade opening. In some examples, detents of the pair of detents are located closer to respective side edges of the pair of side edges than to each other. The blade pocket is contoured to fit the top portion 112 of the utility blade 100 that includes the pair of openings 110, and the pair of detents are contoured to fit within the pair of openings to position and hold the top portion of the utility blade within the blade pocket.

In some examples, the blade pocket 1100 is structured such that a normal force (shown as force \vec{F}_{N} in FIG. 7) against the linear cutting edge 106 of the utility blade 100 proximate a first detent 1108A of the pair of detents 1108 promotes rotation of the utility blade about the first detent, and such that the rotation is resisted by a second detent 1108B of the pair of detents.

As shown in FIG. 11, in some examples, the pair of detents 1108 defined by the blade pocket 1100 (for utility blade 100) include protrusions 1110 defined by respective side edges of the pair of side edges 1106. The protrusions may have any of a number of different such as a convex arcuate shape (shown), a U-shape, V-shape or the like. In some examples, each protrusion defined by a side edge of the respective side edges has a convex arcuate shape, and the side edge includes a concave arcuate transition 1112 from the protrusion to the top edge 1102. These protrusions may be contoured to fit the indentations 114 of utility blade 100.

In some examples, the top edge 1102 of the blade pocket 1100 defines one or more further detents that are contoured to fit one or more indentations 320 on the utility blade 100. These one or more further detents may have any of a number of different such as a U-shape, V-shape or the like.

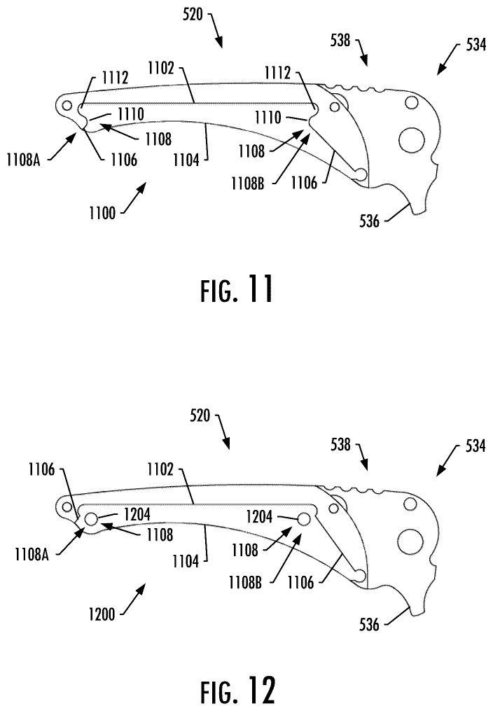

FIG. 12 illustrates the housing 520 including a blade pocket 1200 contoured to fit the top portion 112 of utility blade 200, according to other example implementations. The blade pocket 1200 is similar to the blade pocket 1100, including that it defines a pair of detents 1108 located proximate a pair of side edges 1106. As shown in FIG. 12, in some examples, the blade pocket 1200 (for utility blade 200) further defines a back wall 1202, and detents of the pair of detents are pins 1204 that extend from the back wall, located proximate to but spatially separated from the pair of side edges 1106. These pins may be contoured to fit within the holes 214 of utility blade 200.

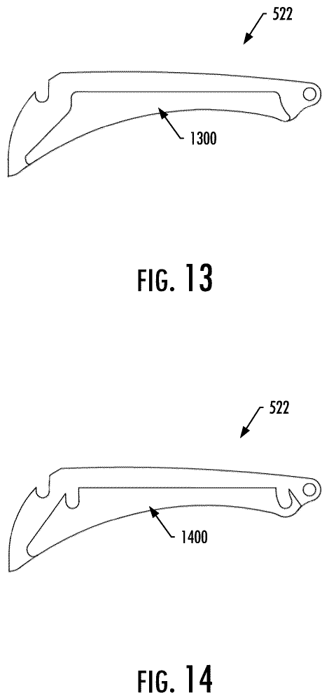

Similar to the blade pocket 1100, 1200, in some examples, the cover 522 that is securable to the housing 520 includes a boss (on an interior surface of the cover) that is contoured to the top portion of the utility blade. The boss is held against the top portion of the utility blade 506 when the cover is secured to the housing. In this regard, FIG. 13 illustrates the cover including a boss 1300 that is contoured to the top portion 112 of the utility blade 100. And FIG. 14 illustrates the cover including a boss 1400 that is contoured to the top portion of the utility blade 200.

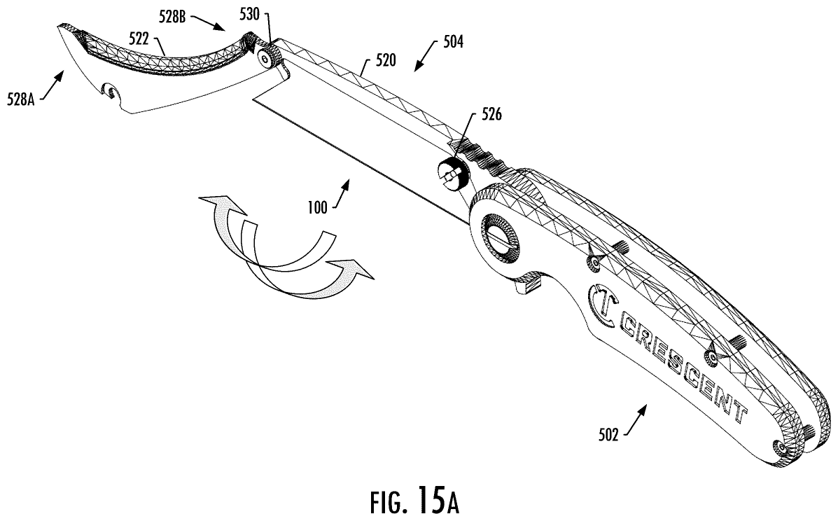

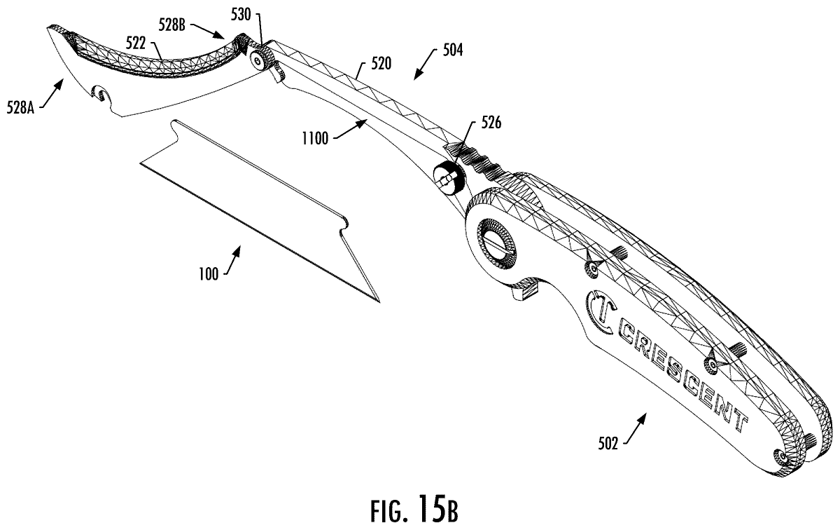

FIGS. 15A and 15B further illustrate the cover 522 secured to the housing 520 of the blade carrier 504 configured to hold utility blade 100, according to some example implementations. As shown, the blade carrier 504 may include a tensioning fastener 526 located proximate the handle 502, and configured to removably secure the first end 528A of the cover to the housing; and a pivot pin 530 configured to pivotably secure the second end 528B of the cover to the housing. The tensioning fastener may be loosened, and the second end of the cover pivoted away from the tensioning fastener (and thereby the handle) to provide access to the blade pocket 1100 of the housing for insertion or replacement of the utility blade. The second end of the cover may then be pivoted back toward the tensioning fastener, and the tensioning fastener tightened to hold the utility blade firmly in the blade pocket.

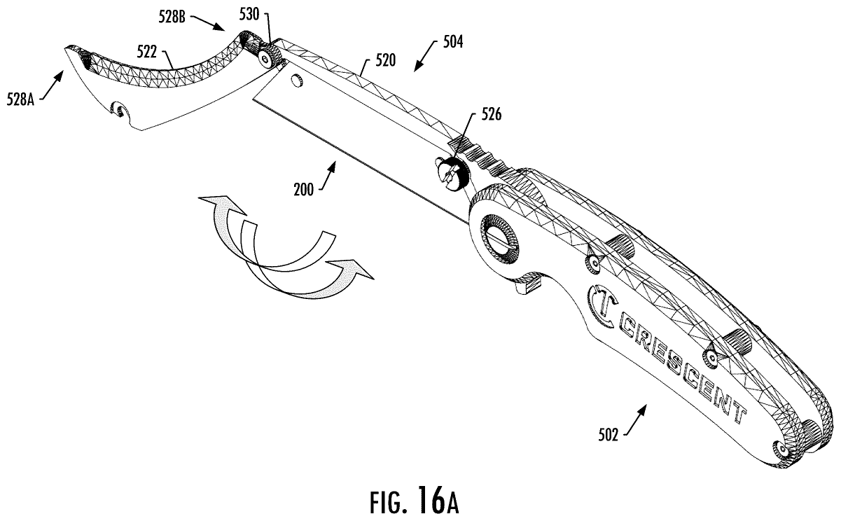

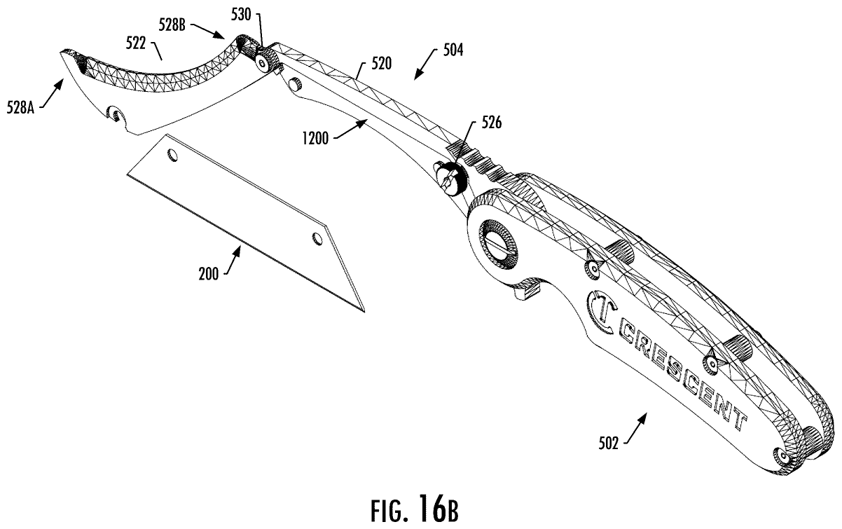

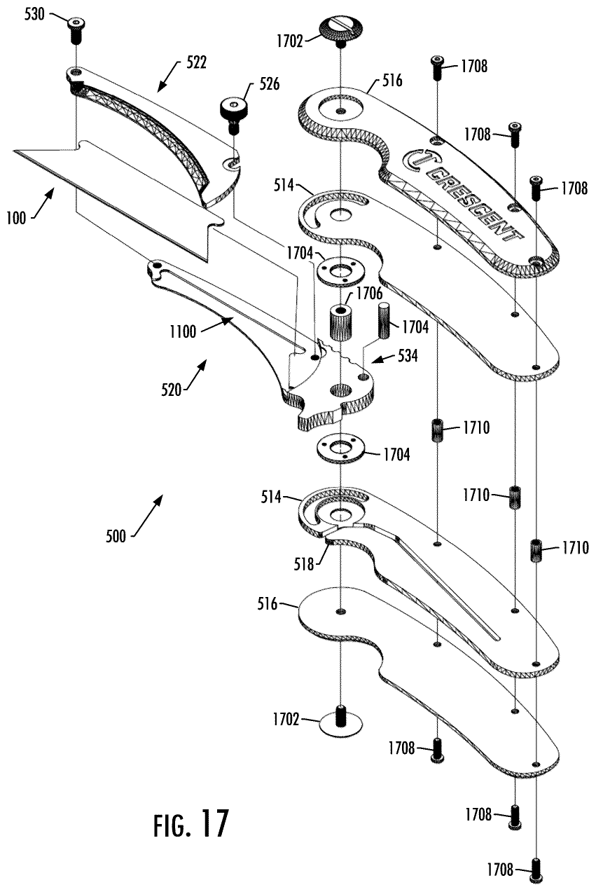

FIGS. 16A and 16B further illustrate the cover 522 secured to the housing 520 of the blade carrier 504 configured to hold utility blade 200, according to some example implementations. Similar to before, the blade carrier 504 may include a tensioning fastener 526 located proximate the handle 502, and a pivot pin 530 configured to pivotably secure the second end 528B of the cover to the housing. The tensioning fastener may be loosened, and the second end of the cover pivoted away from the tensioning fastener (and thereby the handle) to provide access to the blade pocket 1200 of the housing for insertion or replacement of the utility blade. The second end of the cover may then be pivoted back toward the tensioning fastener, and the tensioning fastener tightened to hold the utility blade firmly in the blade pocket.

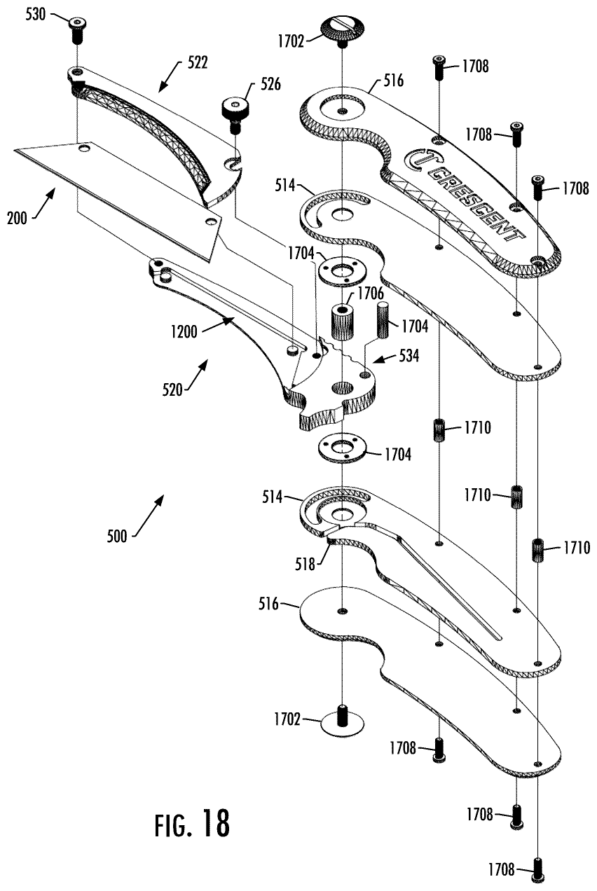

FIG. 17 is an exploded view of the folding utility knife 500 in which the blade carrier 504 is configured to hold a utility blade 100, according to some example implementations. FIG. 18 is similarly an exploded view of the folding utility knife 500 in which the blade carrier 504 is configured to hold a utility blade 200, according to some example implementations. Again, the blade carrier may include a tensioning fastener 526 and a pivot pin 530 to secure the cover 522 to the housing 520. The blade carrier 504 may be pivotably secured to the handle 502 with a pivot that includes pivot screws 1702, thrust ball bearings 1704 and a barrel 1706. The handle includes liners 514 and scales 516 that may be secured together using screws 1708, and standoffs 1710 that sets the spaced apart relationship that defines the interior space 508 of the folding utility knife. A rotation stop pin 1712 may also be included to stop the blade carrier 504 in the open position when pivoted from the closed position, and in the closed position pivoted from the open position.

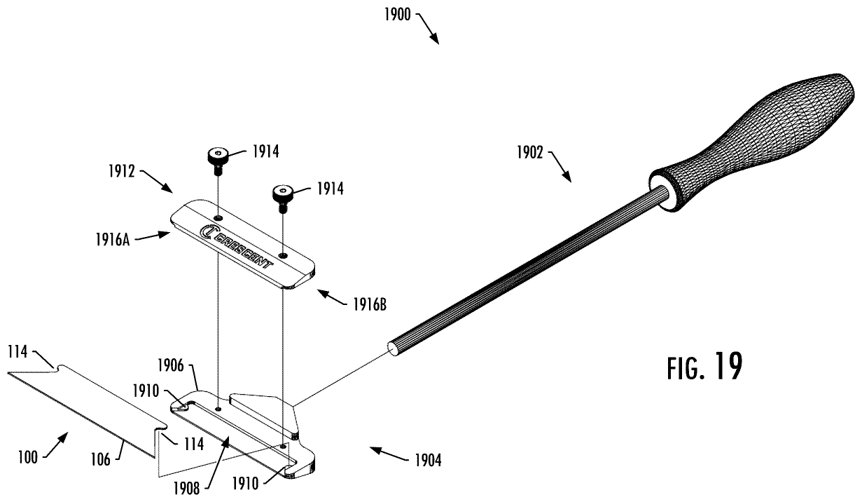

Briefly returning to FIGS. 1 and 2, as explained above, the utility blade 100, 200 may be fit to any of a number of different holders, some of which may be embodied as a blade carrier for a retractable utility knife, a foldable utility knife, a scraper or the like. FIG. 19 is an exploded view of a utility scraper 1900 according to various example implementations of the present disclosure. As shown, for example, the folding utility knife includes a handle 1902, and a blade carrier 1904 that is secured to the handle. The blade carrier is configured to hold a utility blade that in the illustrated implementation corresponds to utility blade 100.

The blade carrier 1904 includes a housing 1906 for receipt of the utility blade 100; and in some examples, the housing defines a blade pocket 1908 contoured to fit the top portion 112 of the utility blade. In this regard, the blade pocket may define edges similar to those described above for blade pocket 1100, and the blade pocket may further define protrusions 1910 (a pair of detents). The blade pocket, then, is contoured to fit the top portion of the utility blade 100 that includes the indentations 114, and the protrusions are contoured to fit within the indentations to position and hold the top portion of the utility blade within the blade pocket. In some examples, the housing is sized such that all of the linear cutting edge 106 of the utility blade is exposed.

As also shown, in some examples, the blade carrier 1904 includes a cover 1912 that is securable to the housing 1906 over the top portion of the utility blade 100 to hold the utility blade firmly in the housing, or more particularly in the blade pocket 1908 of the housing. In some of these examples, the housing and the cover are sized such that none of the linear cutting edge 106 of the utility blade is covered when the top portion 112 of the utility blade is fit into the housing and the cover is secured over the top portion of the utility blade. The cover may be secured to the housing of the blade carrier 504 in any of a number of different manners, such as described above in the context of the folding utility knife 500. As shown, the blade carrier includes a pair of tensioning fasteners 1914 configured to secure respective ends 1916A, 1916B of the cover to the housing.

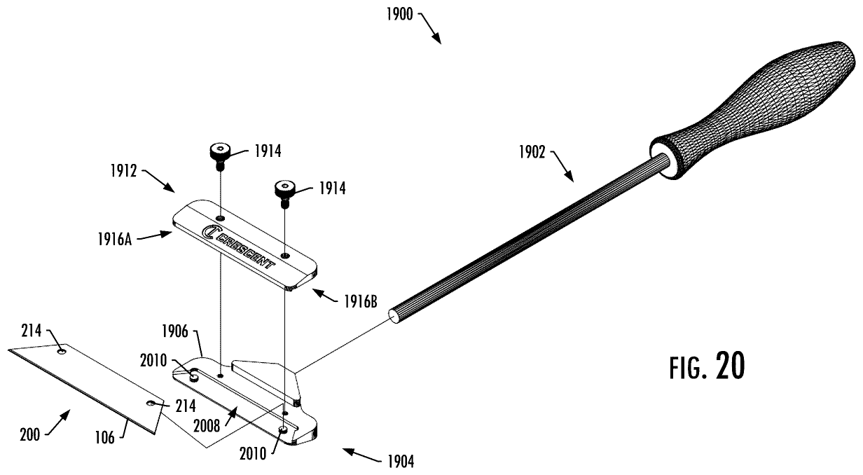

FIG. 20 is an exploded view of a utility scraper 2000 according to other various example implementations in which the blade carrier 1904 is configured to hold a utility blade that in the illustrated implementation corresponds to utility blade 200. The utility scraper in FIG. 20 is similar to utility scraper in FIG. 19; but in in FIG. 20, the housing 1906 defines a blade pocket 2008 contoured to fit the top portion 112 of the utility blade. In this regard, the blade pocket may define edges similar to those described above for blade pocket 1200, and the blade pocket may further define pins 2010 (a pair of detents). The blade pocket, then, is contoured to fit the top portion of the utility blade 200 that includes the holes 214, and the pins are contoured to fit within the holes to position and hold the top portion of the utility blade within the blade pocket.

As explained above and reiterated below, the present disclosure includes, without limitation, the following example implementations.

Clause 1. A utility blade comprising a blade body having a convex quadrilateral shape, the blade body defining at least: a top edge; a linear cutting edge on an opposite side of the blade body from the top edge; a pair of side edges located on opposite sides of the blade body, extending between the top edge and the linear cutting edge; and a pair of openings located proximate the pair of side edges, between the top edge and the linear cutting edge, the pair of openings spatially separated from the top edge and the linear cutting edge, a top portion of the utility blade contoured to fit within a holder that includes a pair of detents, and the pair of openings contoured to fit the pair of detents to position and hold the utility blade within the holder.

Clause 2. The utility blade of clause 1, wherein openings of the pair of openings are located closer to respective side edges of the pair of side edges than to each other.

Clause 3. The utility blade of clause 1 or clause 2, wherein the pair of openings include indentations defined by respective side edges of the pair of side edges.

Clause 4. The utility blade of clause 3, wherein indentations have a concave arcuate shape.

Clause 5. The utility blade of clause 3 or clause 4, wherein indentations have a U-shape or a V-shape.

Clause 6. The utility blade of any of clauses 3 to 5, wherein the indentations are undercuts defined in the respective side edges that leave overhanging portions of the top edge.

Clause 7. The utility blade of clause 6, wherein each undercut defined by a side edge of the respective side edges has a concave arcuate shape, and the side edge includes a convex arcuate transition from the undercut to a respective one of the overhanging portions of the top edge.

Clause 8. The utility blade of any of clauses 1 to 7, wherein openings of the pair of openings are holes defined in the blade body, located proximate to but spatially separated from the pair of side edges.

Clause 9. The utility blade of any of clauses 1 to 8, wherein the top edge defines one or more indentations that are contoured to fit one or more further detents within the holder.

Clause 10. The utility blade of clause 9, wherein the one or more indentations have a U-shape or a V-shape.

Clause 11. A holder for a utility blade that includes a pair of openings, the holder comprising a housing in which a blade pocket is formed, the blade pocket defining at least: a top edge; a blade opening on an opposite side of the blade pocket from the top edge; a pair of side edges located on opposite sides of the blade pocket, extending between the top edge and the blade opening; and a pair of detents located proximate the pair of side edges, between the top edge and the blade opening, the pair of detents spatially separated from the top edge and the blade opening, the blade pocket contoured to fit a top portion of the utility blade, and the pair of detents contoured to fit within the pair of openings to position and hold the top portion of the utility blade within the blade pocket.

Clause 12. The holder of clause 11, wherein the holder is embodied as a blade carrier of a retractable utility knife that also includes a handle to which the blade carrier is slidably connected.

Clause 13. The holder of clause 11 or clause 12, wherein the holder is embodied as a blade carrier of a folding utility knife that also includes a handle to which the blade carrier is pivotably connected.

Clause 14. The holder of any of clauses 11 to 13, wherein the holder is embodied as a blade carrier of a scraper that also includes a handle to which the blade carrier is pivotably connected.

Clause 15. The holder of any of clauses 11 to 14, wherein the housing is sized such that more than 75% of a linear cutting edge of the utility blade is exposed when the top portion of the utility blade is fit into the blade pocket of the housing.

Clause 16. The holder of clause 15, wherein the housing is sized such that all of the linear cutting edge of the utility blade is exposed.

Clause 17. The holder of any of clauses 11 to 16, wherein the blade pocket is structured such that a normal force against a linear cutting edge of the utility blade proximate a first detent of the pair of detents promotes rotation of the utility blade about the first detent, and such that the rotation is resisted by a second detent of the pair of detents.

Clause 18. The holder of any of clauses 11 to 17, wherein the holder further comprises a cover that is securable to the housing over the top portion of the utility blade to hold the utility blade firmly in the blade pocket of the housing.

Clause 19. The holder of clause 18, wherein the cover includes a boss that is contoured to the top portion of the utility blade, and that is held against the top portion of the utility blade when the cover is secured to the housing.

Clause 20. The holder of clause 18 or clause 19, wherein the housing and the cover are sized such that less than 25% of a linear cutting edge of the utility blade is covered when the top portion of the utility blade is fit into the blade pocket of the housing and the cover is secured over the top portion of the utility blade.

Clause 21. The holder of clause 20, wherein the housing and the cover are sized such that none of the linear cutting edge of the utility blade is covered.

Clause 22. The holder of any of clauses 18 to 21, wherein the holder further comprises at least one fastener configured to secure the cover to the housing.

Clause 23. The holder of clause 22, wherein the at least one fastener includes a tensioning fastener loosened to provide access to the blade pocket for insertion or replacement of the utility blade, and tightened to hold the utility blade firmly in the blade pocket.

Clause 24. The holder of clause 23, wherein the tensioning fastener is a thumb screw.

Clause 25. The holder of any of clauses 22 to 24, wherein the at least one fastener includes a pair of tensioning fasteners configured to secure respective ends of the cover to the housing.

Clause 26. The holder of any of clauses 22 to 25, wherein the at least one fastener includes a tensioning fastener configured to removably secure a first end of the cover to the housing, and a pivot pin configured to pivotably secure a second end of the cover to the housing.

Clause 27. The holder of any of clauses 11 to 26, wherein detents of the pair of detents are located closer to respective side edges of the pair of side edges than to each other.

Clause 28. The holder of any of clauses 11 to 27, wherein the pair of detents include protrusions defined by respective side edges of the pair of side edges.

Clause 29. The holder of clause 28, wherein the protrusions have a convex arcuate shape.

Clause 30. The holder of clause 28 or clause 29, wherein the protrusions have a U-shape or a V-shape.

Clause 31. The holder of any of clauses 28 to 30, wherein each protrusion defined by a side edge of the respective side edges has a convex arcuate shape, and the side edge includes a concave arcuate transition from the protrusion to a respective one of the overhanging portions of the top edge.

Clause 32. The holder of any of clauses 11 to 31, wherein the blade pocket further defines a back wall, and detents of the pair of detents are pins that extend from the back wall, located proximate to but spatially separated from the pair of side edges.

Clause 33. The holder of any of clauses 11 to 32, wherein the top edge defines one or more further detents that are contoured to fit one or more indentations on the utility blade.

Clause 34. The holder of clause 33, wherein the one or more further detents have a U-shape or a V-shape.

Clause 35. A folding utility knife comprising: a handle; and a blade carrier that is pivotably secured to the handle, the blade carrier pivotable between a closed position in which the blade carrier is pivoted inwardly toward the handle, and an open position in which the blade carrier is pivoted outwardly relative to the handle, the blade carrier including a housing in which a blade pocket is formed, the blade pocket defining at least: a top edge; a blade opening on an opposite side of the blade pocket from the top edge; a pair of side edges located on opposite sides of the blade pocket, extending between the top edge and the blade opening; and a pair of detents located proximate the pair of side edges, between the top edge and the blade opening, spatially separated from the top edge and the blade opening, the blade pocket contoured to fit a top portion of a utility blade that includes a pair of openings, and the pair of detents contoured to fit within the pair of openings to position and hold the top portion of the utility blade within the blade pocket.

Clause 36. The folding utility knife of clause 35, wherein the handle includes first and second handle portions that are secured to each other in a spaced apart relationship to define an interior space in which at least a bottom portion of the utility blade that includes a linear cutting edge is stowed when the blade carrier is in the closed position.

Clause 37. The folding utility knife of clause 36, wherein the first and second handle portions are scales, and one of the scales is configured as or includes a frame lock configured to engage when the blade carrier is pivoted to the open position, and disengage responsive to an applied force to enable the blade carrier to pivot from the open position to the closed position.

Clause 38. The folding utility knife of clause 36 or clause 37, wherein the first and second handle portions include respective liners and scales, and one of the liners is configured as or includes a liner lock configured to engage when the blade carrier is pivoted to the open position, and disengage responsive to an applied force to enable the blade carrier to pivot from the open position to the closed position.

Clause 39. The folding utility knife of any of clauses 35 to 38, wherein the blade carrier further includes a tang secured to or integrated with the housing, the blade carrier pivotably secured to the handle at the tang.

Clause 40. The folding utility knife of clause 39, wherein the tang includes a tab that juts out from a back of the handle when the blade carrier is in the closed position, a force applied to the tab promoting pivot of the blade carrier from the closed position to the open position.

Clause 41. The folding utility knife of clause 39 or clause 40, wherein the tang includes jumping with a series of notches configured to provide a thumb grip on the blade carrier when the blade carrier is in the open position.

Clause 42. The folding utility knife of any of clauses 35 to 41, wherein the housing of the blade carrier is sized such that more than 75% of a linear cutting edge of the utility blade is exposed when the top portion of the utility blade is fit into the blade pocket of the housing.

Clause 43. The folding utility knife of clause 42, wherein the housing is sized such that all of the linear cutting edge of the utility blade is exposed.

Clause 44. The folding utility knife of any of clauses 35 to 43, wherein the blade pocket is structured such that a normal force against a linear cutting edge of the utility blade proximate a first detent of the pair of detents promotes rotation of the utility blade about the first detent, and such that the rotation is resisted by a second detent of the pair of detents.

Clause 45. The folding utility knife of any of clauses 35 to 44, wherein the blade carrier further includes a cover that is securable to the housing over the top portion of the utility blade to hold the utility blade firmly in the blade pocket of the housing.

Clause 46. The folding utility knife of clause 45, wherein the cover includes a boss that is contoured to the top portion of the utility blade, and that is held against the top portion of the utility blade when the cover is secured to the housing.

Clause 47. The folding utility knife of clause 45 or clause 46, wherein the housing and the cover are sized such that less than 25% of a linear cutting edge of the utility blade is covered when the top portion of the utility blade is fit into the blade pocket of the housing and the cover is secured over the top portion of the utility blade.

Clause 48. The folding utility knife of clause 47, wherein the housing and the cover are sized such that none of the linear cutting edge of the utility blade is covered.

Clause 49. The folding utility knife of any of clauses 45 to 48, wherein the blade carrier further includes at least one fastener configured to secure the cover to the housing.

Clause 50. The folding utility knife of clause 49, wherein the a least one fastener includes a tensioning fastener loosened to provide access to the blade pocket for insertion or replacement of the utility blade, and tightened to hold the utility blade firmly in the blade pocket.

Clause 51. The folding utility knife of clause 50 wherein the tensioning fastener is a thumb screw.

Clause 52. The folding utility knife of any of clauses 49 to 51, wherein the at least one fastener includes a pair of tensioning fasteners configured to secure respective ends of the cover to the housing.

Clause 53. The folding utility knife of any of clauses 49 to 52, wherein the at least one fastener includes a tensioning fastener configured to removably secure a first end of the cover to the housing, and a pivot pin configured to pivotably secure a second end of the cover to the housing.

Clause 54. The folding utility knife of clause 53, wherein the tensioning fastener is located proximate the handle, and the pivot pin is located proximate a distal end of the housing of the blade carrier.

Clause 55. The folding utility knife of clause 54, wherein the tensioning fastener is located proximate the handle, as a thumb stud in which a force applied to the thumb stud promotes pivot of the blade carrier from the closed position to the open position.

Clause 56. The folding utility knife of any of clauses 35 to 55, wherein detents of the pair of detents are located closer to respective side edges of the pair of side edges than to each other.

Clause 57. The folding utility knife of any of clauses 35 to 56, wherein the pair of detents include protrusions defined by respective side edges of the pair of side edges.

Clause 58. The folding utility knife of clause 57, wherein the protrusions have a convex arcuate shape.

Clause 59. The folding utility knife of clause 57 or clause 58, wherein the protrusions have a U-shape or a V-shape.

Clause 60. The folding utility knife of any of clauses 57 to 59, wherein each protrusion defined by a side edge of the respective side edges has a convex arcuate shape, and the side edge includes a concave arcuate transition from the protrusion to a respective one of the overhanging portions of the top edge.

Clause 61. The folding utility knife of any of clauses 35 to 60, wherein the blade pocket further defines a back wall, and detents of the pair of detents are pins that extend from the back wall, located proximate to but spatially separated from the pair of side edges.

Clause 62. The folding utility knife of any of clauses 35 to 61, wherein the top edge defines one or more further detents that are contoured to fit one or more indentations on the utility blade.

Clause 63. The folding utility knife of clause 62, wherein the one or more further detents have a U-shape or a V-shape.

Clause 64. The folding utility knife of any of clauses 35 to 63, wherein the folding utility knife further comprises the utility blade.

Clause 65. The folding utility knife of clause 64, wherein the utility blade includes a blade body having a convex quadrilateral shape, the blade body defining the pair of openings of the utility blade, and further defining at least: a blade top edge; a linear cutting edge on an opposite side of the blade body from the blade top edge; and a pair of blade side edges located on opposite sides of the blade body, extending between the blade top edge and the linear cutting edge, and wherein the pair of openings are located proximate the pair of blade side edges, between the blade top edge and the linear cutting edge, the pair of openings spatially separated from the blade top edge and the linear cutting edge.

Clause 66. The folding utility knife of clause 65, wherein openings of the pair of openings are located closer to respective blade side edges of the pair of blade side edges than to each other.

Clause 67. The folding utility knife of clause 65 or clause 66, wherein the pair of openings include indentations defined by respective blade side edges of the pair of blade side edges.

Clause 68. The folding utility knife of clause 67, wherein indentations have a concave arcuate shape.

Clause 69. The folding utility knife of clause 67 or clause 68, wherein indentations have a U-shape or a V-shape.

Clause 70. The folding utility knife of any of clauses 67 to 69, wherein the indentations are undercuts defined in the respective blade side edges that leave overhanging portions of the blade top edge.

Clause 71. The folding utility knife of clause 70, wherein each undercut defined by a blade side edge of the respective blade side edges has a concave arcuate shape, and the blade side edge includes a convex arcuate transition from the undercut to a respective one of the overhanging portions of the blade top edge.

Clause 72. The folding utility knife of any of clauses 65 to 71, wherein openings of the pair of openings are holes defined in the blade body, located proximate to but spatially separated from the pair of blade side edges.

Clause 73. The folding utility knife of any of clauses 65 to 72, wherein the top edge of the blade pocket defines one or more further detents, and the blade top edge defines one or more indentations that are contoured to fit the one or more further detents.

Clause 74. The folding utility knife of clause 73, wherein the one or more indentations have a U-shape or a V-shape.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A folding utility knife comprising:
a handle; and
a blade carrier that is pivotably secured to the handle, the blade carrier pivotable between a closed position in which the blade carrier is pivoted inwardly toward the handle, and an open position in which the blade carrier is pivoted outwardly relative to the handle, the blade carrier including a housing in which a blade pocket is formed, the blade pocket defining at least:
a top edge;
a blade opening on an opposite side of the blade pocket from the top edge;
a pair of side edges located on opposite sides of the blade pocket, extending between the top edge and the blade opening; and
a pair of detents located proximate the pair of side edges, between the top edge and the blade opening, spatially separated from the top edge and the blade opening, the blade pocket contoured to fit a top portion of a utility blade that includes a pair of openings, and the pair of detents contoured to fit within the pair of openings to position and hold the top portion of the utility blade within the blade pocket.

2. The folding utility knife of claim 1, wherein the handle includes first and second handle portions that are secured to each other in a spaced apart relationship to define an interior space in which at least a bottom portion of the utility blade that includes a linear cutting edge is stowed when the blade carrier is in the closed position.

3. The folding utility knife of claim 2, wherein the first and second handle portions are scales, and one of the scales is configured as or includes a frame lock configured to engage when the blade carrier is pivoted to the open position, and disengage responsive to an applied force to enable the blade carrier to pivot from the open position to the closed position.

4. The folding utility knife of claim 2, wherein the first and second handle portions include respective liners and scales, and one of the liners is configured as or includes a liner lock configured to engage when the blade carrier is pivoted to the open position, and disengage responsive to an applied force to enable the blade carrier to pivot from the open position to the closed position.

5. The folding utility knife of claim 1, wherein the blade carrier further includes a tang secured to or integrated with the housing, the blade carrier pivotably secured to the handle at the tang.

6. The folding utility knife of claim 5, wherein the tang includes a tab that juts out from a back of the handle when the blade carrier is in the closed position, a force applied to the tab promoting pivot of the blade carrier from the closed position to the open position.

7. The folding utility knife of claim 5, wherein the tang includes jumping with a series of notches configured to provide a thumb grip on the blade carrier when the blade carrier is in the open position.

8. The folding utility knife of claim 1, wherein the housing of the blade carrier is sized such that more than 75% of a linear cutting edge of the utility blade is exposed when the top portion of the utility blade is fit into the blade pocket of the housing.

9. The folding utility knife of claim 1, wherein the blade pocket is structured such that a normal force against a linear cutting edge of the utility blade proximate a first detent of the pair of detents promotes rotation of the utility blade about the first detent, and such that the rotation is resisted by a second detent of the pair of detents.

10. The folding utility knife of claim 1, wherein the blade carrier further includes a cover that is securable to the housing over the top portion of the utility blade to hold the utility blade firmly in the blade pocket of the housing.

11. The folding utility knife of claim 10, wherein the cover includes a boss that is contoured to the top portion of the utility blade, and that is held against the top portion of the utility blade when the cover is secured to the housing.

12. The folding utility knife of claim 10, wherein the housing and the cover are sized such that less than 25% of a linear cutting edge of the utility blade is covered when the top portion of the utility blade is fit into the blade pocket of the housing and the cover is secured over the top portion of the utility blade.

13. The folding utility knife of claim 10, wherein the blade carrier further includes at least one fastener configured to secure the cover to the housing, and the at least one fastener includes a tensioning fastener loosened to provide access to the blade pocket for insertion or replacement of the utility blade, and tightened to hold the utility blade firmly in the blade pocket.

14. The folding utility knife of claim 10, wherein the blade carrier further includes at least one fastener configured to secure the cover to the housing, and the at least one fastener includes a tensioning fastener configured to removably secure a first end of the cover to the housing, and a pivot pin configured to pivotably secure a second end of the cover to the housing.

15. The folding utility knife of claim 14, wherein the tensioning fastener is located proximate the handle, and the pivot pin is located proximate a distal end of the housing of the blade carrier, and
wherein the tensioning fastener is located proximate the handle, as a thumb stud in which a force applied to the thumb stud promotes pivot of the blade carrier from the closed position to the open position.

16. The folding utility knife of claim 1, wherein detents of the pair of detents are located closer to respective side edges of the pair of side edges than to each other.

17. The folding utility knife of claim 1, wherein the pair of detents include protrusions defined by respective side edges of the pair of side edges.

18. The folding utility knife of claim 17, wherein each protrusion defined by a side edge of the respective side edges has a convex arcuate shape, and the side edge includes a concave arcuate transition from the protrusion to a respective one of the overhanging portions of the top edge.

19. The folding utility knife of claim 1, wherein the blade pocket further defines a back wall, and detents of the pair of detents are pins that extend from the back wall, located proximate to but spatially separated from the pair of side edges.

20. The folding utility knife of claim 1, wherein the folding utility knife further comprises the utility blade.
